(19) United States
(12) Patent Application Publication
(10) Pub. No.: US 2010/0257117 A1
(43) Pub. Date: Oct. 7, 2010

(54) PREDICTIONS BASED ON ANALYSIS OF ONLINE ELECTRONIC MESSAGES

(75) Inventors: Gadi SHVADRON, Tel Aviv (IL); Yoram Bachrach, Jerusalem (IL); Emil Ismalon, Tel Aviv (IL); Omri Braun, Kfar Rut (IL)

Correspondence Address: SUGHRUE MION, PLLC, 2100 PENNSYLVANIA AVENUE, N.W., SUITE 800, WASHINGTON, DC, 20037, US

(73) Assignee: Bulloons.com LTD., Tel Aviv (IL)

(21) Appl. No.: 12/417,940

(22) Filed: Apr. 3, 2009

(51) Int. Cl. G06Q 40/00; G06F 17/30; G06N 5/02

(52) U.S. Cl. 705/36 R; 706/52; 707/E17.017; 707/E17.044

(57) ABSTRACT

A method includes receiving first online messages regarding a financial instrument, and first objective quantitative data that reflect respective first values of a target variable associated with the financial instrument. The first messages are analyzed to generate respective first sentiment scores reflecting respective sentiments expressed in the first messages regarding the financial instrument. An initial prediction model is generated for the target variable by analyzing the first sentiment scores and the associated first values of the target variable. Second messages and objective quantitative data are received and analyzed to generate second sentiment scores and an incremental prediction model. A refined prediction model is generated by combining the initial model with the incremental model. Third messages are received and analyzed to generate third sentiment scores, which are used as input to the refined model to predict a future value of the target variable, which is reported to a user.

### FIELD OF THE INVENTION

The present invention relates generally to automated text analysis, and specifically to apparatus, methods, and software products for analyzing online electronic postings.

### BACKGROUND OF THE INVENTION

The Internet is widely used for expressing opinions regarding nearly all topics of interest. One topic of particular interest to many users of the Internet is sentiments regarding financial instruments, such as publicly-traded equity securities. Such interested users express sentiments regarding financial instruments in online messages posted to online electronic discussion forums and message boards, messages posted to online groups (e.g., USENET news groups), messages posted to electronic mailing lists, articles published on the World Wide Web, and financial asset recommendation reports published on the World Wide Web. Such messages may be posted, for example, by individual investors, bloggers, financial companies, journalists, and analysts. Online electronic discussion forums support synchronous and/or asynchronous discussions.

U.S. Pat. Nos. 7,197,470 to Arnett et al. and 7,185,065 to Holtzman et al., which are incorporated herein by reference, describe a system and method for collecting and analyzing electronic discussion messages to categorize the message communications and the identify trends and patterns in pre-determined markets. The system comprises an electronic data discussion system wherein electronic messages are collected and analyzed according to characteristics and data inherent in the messages. The system further comprises a data store for storing the message information and results of any analyses performed. Objective data is collected by the system for use in analyzing the electronic discussion data against real-world events to facilitate trend analysis and event forecasting based on the volume, nature and content of messages posted to electronic discussion forums.

The following patents, all of which are incorporated herein by reference, may be of interest:

U.S. Pat. No. 7,130,777 to Garg et al.

U.S. Pat. No. 7,146,416 to Yoo et al.

U.S. Pat. No. 6,606,644 to Ford et al.

U.S. Pat. No. 6,393,460 to Gruen et al.

U.S. Pat. No. 7,155,510 to Kaplan

U.S. Pat. No. 6,236,980 to Reese

U.S. Pat. No. 7,072,883 to Potok et al.

U.S. Pat. No. 6,859,807 to Knight et al.

U.S. Pat. No. 6,108,493 to Miller et al.

U.S. Pat. No. 7,299,204 to Peng et al.

U.S. Pat. No. 5,371,673 to Fan

### SUMMARY OF THE INVENTION

In some embodiments of the present invention, a sentiment analysis and prediction system analyzes online electronic messages to predict changes in financial instrument variables, such as prices, and identifies and displays information regarding the most significant messages. The system collects message information regarding the online messages, and objective quantitative market information regarding financial instruments, such as prices, changes in prices, and trading volumes. The system processes the messages and market information, and stores the results of the analysis in a profile database. The system analyzes the stored information to identify significant messages and message authors, and to make predictions regarding future prices of the financial instruments. The analysis may include identifying patterns and trends in the sentiments expressed in the messages, and patterns and trends in the objective market information.

The system comprises a model generation engine that uses machine learning techniques to produce a prediction model, by analyzing the sentiments stored in the profile database and corresponding objective market information. The system uses the generated model to predict future market events, based on the current profile of message and market information, and generates reports displaying the predicted market events. For example, the predictions regarding future market events may include numerical predictions regarding future prices and/or trading volumes of financial instruments; future changes in prices and/or trading volumes; future trends, such as price and/or trading volume trends; and/or the probability of significant future market events. The model generation engine uses machine learning techniques to generate an accurate prediction model, based on the relation between the profile and the financial instrument prices in the past.

In some embodiments of the present invention, the system stores structured summaries of the online messages, rather than the complete textual contents of the raw messages. The structured summaries include key elements of the messages. The model generation engine uses the structured summaries, as stored in the profile database, rather than the raw messages, to generate the model. The key elements of the messages stored in the summaries may include, for example, the sentiments expressed in the messages regarding one or more financial instruments or other topics (typically expressed as a numerical value), an identifier of the financial instrument (e.g., a stock symbol) or topic, key words of the message, and/or the message length. Because the structured summaries are generally substantially shorter than the raw messages, the system is able efficiently scale to analyze very large numbers of messages while keeping the model up-to-date. Alternatively or additionally, the system stores the complete raw messages, or portions thereof.

The model generation engine typically generates and maintains the prediction model using dynamic algorithms and model refinement, rather than predetermined or static rules. For some applications, the model generation engine frequently updates the prediction model, such that the engine is generally constantly learning. For example, such updating may be performed upon receiving each newly-posted online message and/or each change in target financial instrument value, or periodically, such as once per second, once per minute, or once per hour. Such frequent updating of the model generally results in more accurate predictions.

In some embodiments of the present invention, the model generation engine generates a full new model periodically, such as once per week or once per day, and more frequently incrementally refines the model, such as upon receipt of each new message, and/or once per second, minute, or hour. Such incremental updating generates better predictions than could be achieved if the model were updated infrequently. Although still more accurate predictions could be achieved if the engine frequently generated a full new model, such new model generation is generally prohibitively computationally intensive. Frequent incremental refinement of infrequently generated new models strikes an effective balance, which enables reasonably accurate predictions within processing constraints.

In some embodiments of the present invention, the system analyzes the stored structured message summaries and stored objective quantitative market information that occurred after publication of the messages, in order to identify the most important messages and/or most important authors. For example, messages may be identified as important responsively to the correlation between the sentiment expressed in each of the messages and the objective market data that occurred after publication of the message, the correlation between the sentiment expressed in each of the messages and sentiment of other messages, or a statistical analysis of variance test (ANOVA). For some applications, the system generates a report displaying this information about the most important messages or most important authors.

In some embodiments of the present invention, a report generator of the system generates a report displaying information about the current general sentiment regarding a certain financial instrument, based on the analyses described herein, past objective quantitative market information, and/or structured message summaries. The report reflects the general sentiment of the author community regarding the financial instrument, and may include information regarding the messages themselves. For example, the report may contain aggregate information about the sentiments expressed in the messages regarding the financial instrument, data about the main issues discussed in the messages, and/or a clustering of the messages according to topics.

In some embodiments of the present invention, the system is configured to infer sentiments of a particular author regarding a financial instrument of a corporation even when the author has posted a message that implicitly but not explicitly indicates a sentiment regarding the financial instrument. The system infers the author's sentiment regarding the financial instrument by identifying other authors as having opinions similar to those of the particular author regarding the financial instrument or another aspect of the corporation. For example, the other authors and the particular author may have expressed similar sentiments regarding the particular financial instrument at approximately the same time in the past. The system makes the assumption that the particular author would currently share the sentiments of these other authors, particularly if the particular author and other authors express similar opinions in their most recent messages regarding an aspect of the corporation other than its financial instrument. For some applications, the system identifies such shared sentiments by comparing the stored structured summaries of messages posted by the authors. Alternatively or additionally, the system predicts such sentiments using sentiments the particular author posts regarding other financial instruments that have characteristics in common with the particular financial instrument.

In some embodiments of the present invention, the analysis and prediction techniques described herein are used to analyze online electronic messages to predict changes in target variables associated with objects other than financial instruments. Such objects may be tangible or intangible. For example, the objects may comprises a physical article of manufacture, such as a consumer or business product, or an online advertisement. The target variable may be, for example, a level of sales of the object, or a level of online traffic generated by the object. Sentiments may thus be analyzed to assess the prospects of the object by predicting the value of a target variable associated with the object, which variable is indicative of a measure of success of the object. Furthermore, the techniques described herein may be used to assess a quality level or efficiency measure of a manufacturing process, or a level of employee satisfaction, by analyzing messages posted by employees, for example.

As used in the present application, including in the claims, “online messages” include, but are not limited to, messages posted to online electronic discussion forums and message boards, messages posted to online groups (e.g., USENET news groups), messages posted to chat groups, messages posted to electronic mailing lists, articles published on the World Wide Web, and financial asset recommendation reports published on the World Wide Web. Such messages may be posted, for example, by individual investors, bloggers, financial companies, journalists, and analysts. As used in the present application, including in the claims, “online message servers” include, but are not limited to, online servers that host online discussion forums, online message boards, online groups (e.g., USENET news groups), chat groups, electronic mailing lists, and online publications, such as of articles, opinion pieces, or recommendations. Such online message servers may allow synchronous and/or asynchronous posting of messages. As used in the present application, including in the claims, “financial instruments” include, but are not limited to, publicly-traded equity securities (e.g., common stocks), debt securities (e.g., bonds), exchange-traded funds (ETFs), commodities, and derivatives.

There is therefore provided, in accordance with an embodiment of the present invention, a computer-implemented method including:

scanning online message servers to identify a plurality of first messages posted during a first period of time, which first messages contain information regarding a financial instrument;

receiving first objective quantitative data reflecting respective first values of a target variable associated with the financial instrument, such first values measured after the respective first messages are posted;

analyzing the first messages to generate respective first sentiment scores reflecting respective sentiments expressed in the first messages regarding the financial instrument;

generating an initial mathematical prediction model for the target variable by analyzing the first sentiment scores and the associated first values of the target variable;

scanning the online message servers to identify one or more second messages posted during a second period of time after the first period of time, which second messages contain information regarding the financial instrument;

receiving second objective quantitative data reflecting respective second values of the target variable associated with the financial instrument, such second values measured after the second messages are posted;

analyzing the second messages to generate respective second sentiment scores reflecting respective sentiments expressed in the second messages regarding the financial instrument;

generating an incremental mathematical prediction model for the target variable by analyzing the second sentiment scores and the associated second values of the target variable;

generating a refined mathematical prediction model by combining the initial prediction model with the incremental prediction model;

scanning the online message servers to identify a plurality of third messages posted during a third period of time after the second period of time, which third messages contain information regarding the financial instrument;

analyzing the third messages to generate respective third sentiment scores reflecting respective sentiments expressed in the third messages regarding the financial instrument;

predicting a future value of the target variable using the refined prediction model with the third sentiment scores as input thereto; and reporting, to a user, an indicator of the future value of the target variable in association with an identifier of the financial instrument.

Typically, generating the incremental and refined prediction models includes generating a plurality of incremental and refined prediction models based on the initial prediction model. For example, generating the plurality of incremental and refined prediction models may include generating a new one of the incremental models and a new one of the refined models upon the posting of each of the second messages.

For some applications, combining the initial prediction model with the incremental prediction model includes setting the refined prediction model equal to a weighted average of predictions generated by the initial prediction model and predictions generated by the incremental prediction model.

In an embodiment, analyzing the first messages to generate the respective first sentiment scores includes generating and storing respective structured summaries of the first messages, which summaries include the respective first sentiment scores and an identity of the financial instrument, and do not include complete textual contents of the respective first messages, and analyzing the first sentiment scores includes reading the first sentiment scores from the respective structured summaries.

In an embodiment, the financial instrument includes a financial instrument of a corporation, and analyzing the first messages to generate the respective first sentiment scores includes analyzing one of the first messages posted by a first author to generate a respective one of the first sentiment scores reflecting a respective one of the sentiments implicitly but not explicitly expressed by the first author in the first message regarding the financial instrument, by inferring the first author's sentiment regarding the financial instrument responsively to: (a) a first similarity between (i) a first previous sentiment expressed by the first author in a previous message and (ii) one or more second previous sentiments expressed by one or more respective second authors in one or more previous messages, and (b) a second similarity between (i) a first current sentiment expressed by the first author in the first message regarding an aspect of the corporation other than the financial instrument and (ii) one or more second current sentiments expressed by the one or more respective second authors in respective ones of the first messages regarding the aspect of the corporation.

In an embodiment, generating the initial prediction model includes identifying one or more topics discussed in respective first messages; ascertaining respective levels of influence of the topics on the first values of the target variable; and assigning respective weights in the initial prediction model to the respective sentiments expressed in the first messages based in part on the respective levels of influences of the topics discussed in the respective first messages.

There is further provided, in accordance with an embodiment of the present invention, a computer system for use with online message servers, the system including:

a web crawler, which is configured to scan the online message servers to identify: (a) a plurality of first messages posted during a first period of time, which first messages contain information regarding a financial instrument, (b) one or more second messages posted during a second period of time after the first period of time, which second messages contain information regarding the financial instrument, and (c) a plurality of third messages posted during a third period of time after the second period of time, which third messages contain information regarding the financial instrument;

a market information collector, which is configured to receive: (a) first objective quantitative data reflecting respective first values of a target variable associated with the financial instrument, such first values measured after the respective first messages are posted, and (b) second objective quantitative data reflecting respective second values of the target variable associated with the financial instrument, such second values measured after the second messages are posted;

a sentiment engine, which is configured to analyze: (a) the first messages to generate respective first sentiment scores reflecting respective sentiments expressed in the first messages regarding the financial instrument, (b) the second messages to generate respective second sentiment scores reflecting respective sentiments expressed in the second messages regarding the financial instrument, and (c) the third messages to generate respective third sentiment scores reflecting respective sentiments expressed in the third messages regarding the financial instrument;

a model generation engine, which is configured to generate an initial mathematical prediction model for the target variable by analyzing the first sentiment scores and the associated first values of the target variable;

a model refiner, which is configured to generate an incremental mathematical prediction model for the target variable by analyzing the second sentiment scores and the associated second values of the target variable, and to generate a refined mathematical prediction model by combining the initial prediction model with the incremental prediction model;

a market prediction engine, which is configured to predict a future value of the target variable using the refined prediction model with the third sentiment scores as input thereto; and

a report generator, which is configured to generate a report including an indicator of the future value of the target variable in association with an identifier of the financial instrument.

Typically, the model refiner is configured to generate a plurality of incremental and refined prediction models based on the initial prediction model.

For example, the model refiner may be configured to generate a new one of the incremental models and a new one of the refined models upon the posting of each of the second messages.

For some applications, the model refiner is configured to combine the initial prediction model with the incremental prediction model by setting the refined prediction model equal to a weighted average of predictions generated by the initial prediction model and predictions generated by the incremental prediction model.

In an embodiment, the system further includes a profile database; and a summary generation module, which is configured to generate and store in the profile database respective structured summaries of the first messages, which summaries include the respective first sentiment scores and an identity of the financial instrument, and do not include complete textual contents of the respective first messages. The model generation engine is configured to analyze the first sentiment scores by reading the first sentiment scores from the respective structured summaries stored in the profile database.

In an embodiment, the financial instrument includes a financial instrument of a corporation, and the sentiment engine is configured to analyze one of the first messages posted by a first author to generate a respective one of the first sentiment scores reflecting a respective one of the sentiments implicitly but not explicitly expressed by the first author in the first message regarding the financial instrument, by inferring the first author's sentiment regarding the financial instrument responsively to: (a) a first similarity between (i) a first previous sentiment expressed by the first author in a previous message and (ii) one or more second previous sentiments expressed by one or more respective second authors in one or more previous messages, and (b) a second similarity between (i) a first current sentiment expressed by the first author in the first message regarding an aspect of the corporation other than the financial instrument and (ii) one or more second current sentiments expressed by the one or more respective second authors in respective ones of the first messages regarding the aspect of the corporation.

In an embodiment of the present invention, the system further includes a message clustering engine, which is configured to identify one or more topics discussed in respective first messages, and the model generation engine is configured to generate the initial prediction model by ascertaining respective levels of influence of the topics on the first values of the target variable, and assigning respective weights in the initial prediction model to the respective sentiments expressed in the first messages based in part on the respective levels of influences of the topics discussed in the respective first messages.

There is still further provided, in accordance with an embodiment of the present invention, apparatus for use with online message servers, the apparatus including:

an interface; and

a processor, configured to scan, via the interface, the online message servers to identify a plurality of first messages posted during a first period of time, which first messages contain information regarding a financial instrument; receive, via the interface, first objective quantitative data reflecting respective first values of a target variable associated with the financial instrument, such first values measured after the respective first messages are posted; analyze the first messages to generate respective first sentiment scores reflecting respective sentiments expressed in the first messages regarding the financial instrument; generate an initial mathematical prediction model for the target variable by analyzing the first sentiment scores and the associated first values of the target variable; scan, via the interface, the online message servers to identify one or more second messages posted during a second period of time after the first period of time, which second messages contain information regarding the financial instrument; receive second objective quantitative data reflecting respective second values of the target variable associated with the financial instrument, such second values measured after the second messages are posted; analyze the second messages to generate respective second sentiment scores reflecting respective sentiments expressed in the second messages regarding the financial instrument; generate an incremental mathematical prediction model for the target variable by analyzing the second sentiment scores and the associated second values of the target variable; generate a refined mathematical prediction model by combining the initial prediction model with the incremental prediction model; scan, via the interface, the online message servers to identify a plurality of third messages posted during a third period of time after the second period of time, which third messages contain information regarding the financial instrument; analyze the third messages to generate respective third sentiment scores reflecting respective sentiments expressed in the third messages regarding the financial instrument; predict a future value of the target variable using the refined prediction model with the third sentiment scores as input thereto; and report, to a user via the interface, an indicator of the future value of the target variable in association with an identifier of the financial instrument.

There is additionally provided, in accordance with an embodiment of the present invention, a computer software product including a tangible computer-readable medium in which program instructions are stored, which instructions, when read by a computer, cause the computer to scan online message servers to identify a plurality of first messages posted during a first period of time, which first messages contain information regarding a financial instrument; receive first objective quantitative data reflecting respective first values of a target variable associated with the financial instrument, such first values measured after the respective first messages are posted; analyze the first messages to generate respective first sentiment scores reflecting respective sentiments expressed in the first messages regarding the financial instrument; generate an initial mathematical prediction model for the target variable by analyzing the first sentiment scores and the associated first values of the target variable; scan the online message servers to identify one or more second messages posted during a second period of time after the first period of time, which second messages contain information regarding the financial instrument; receive second objective quantitative data reflecting respective second values of the target variable associated with the financial instrument, such second values measured after the second messages are posted; analyze the second messages to generate respective second sentiment scores reflecting respective sentiments expressed in the second messages regarding the financial instrument; generate an incremental mathematical prediction model for the target variable by analyzing the second sentiment scores and the associated second values of the target variable; generate a refined mathematical prediction model by combining the initial prediction model with the incremental prediction model; scan the online message servers to identify a plurality of third messages posted during a third period of time after the second period of time, which third messages contain information regarding the financial instrument; analyze the third messages to generate respective third sentiment scores reflecting respective sentiments expressed in the third messages regarding the financial instrument; predict a future value of the target variable using the refined prediction model with the third sentiment scores as input thereto; and report, to a user, an indicator of the future value of the target variable in association with an identifier of the financial instrument.

The present invention will be more fully understood from the following detailed description of embodiments thereof, taken together with the drawings, in which:

### BRIEF DESCRIPTION OF THE DRAWINGS

FIG. 1 is a schematic, pictorial illustration of a network environment including a sentiment analysis and prediction system, in accordance with an embodiment of the present invention;

FIG. 2 is a schematic block diagram illustrating components of the sentiment analysis and prediction system of FIG. 1, in accordance with an embodiment of the present invention;

FIG. 3 is an exemplary screen shot showing an exemplary report generated by a report generator of the system of FIG. 1, in accordance with an embodiment of the present invention; and

FIGS. 4A-B are a flow chart that schematically illustrates a method for analyzing sentiments to predict market variables, in accordance with an embodiment of the present invention.

### DETAILED DESCRIPTION OF EMBODIMENTS

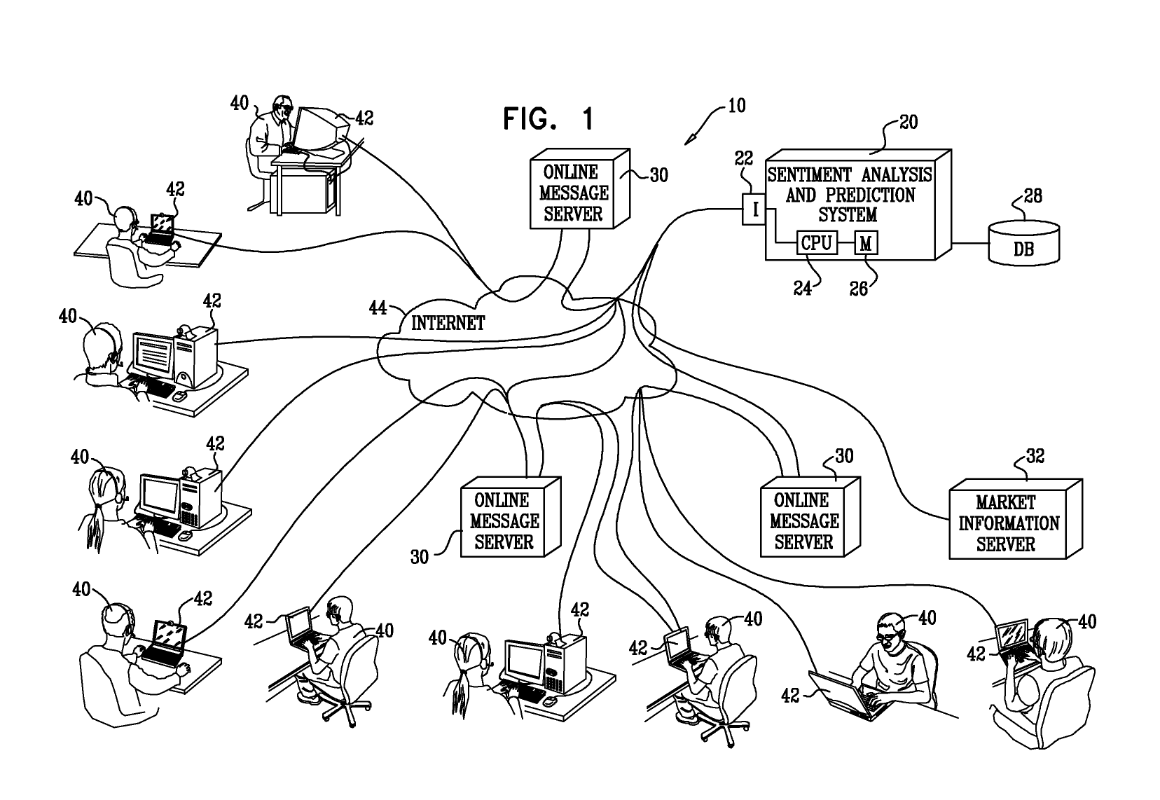

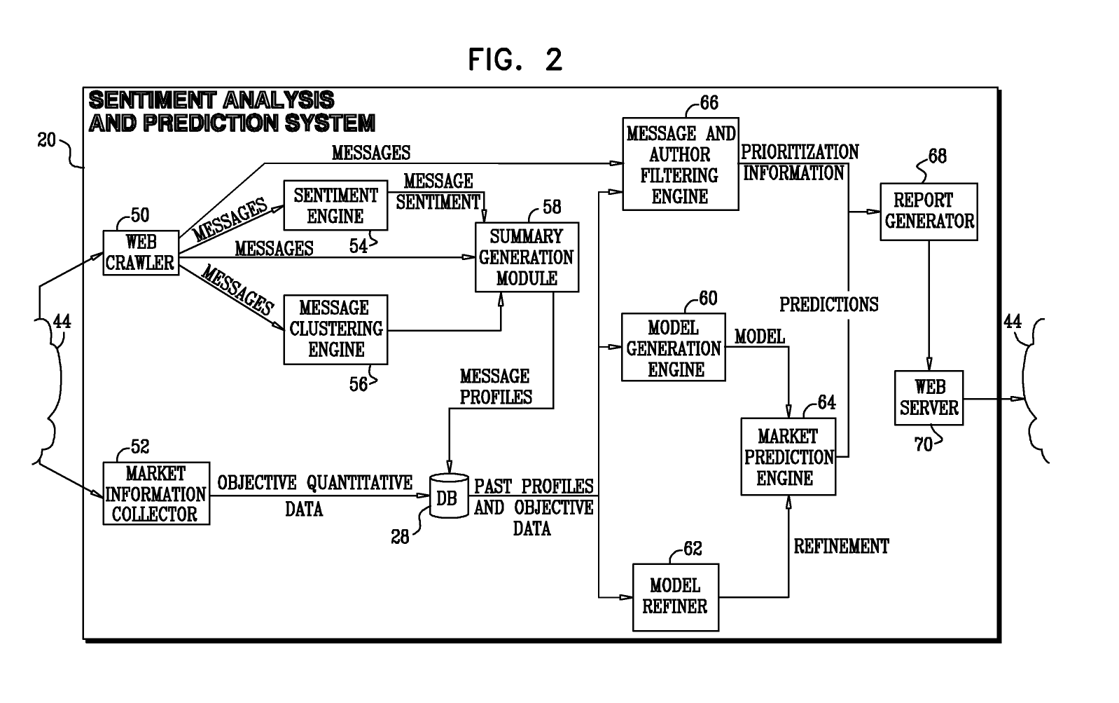

FIG. 1 is a schematic, pictorial illustration of a network environment 10 including a sentiment analysis and prediction system 20, in accordance with an embodiment of the present invention. System 20 comprises a communication interface 22, a central processing unit (CPU) 24, and a memory 26, which typically comprises a non-volatile memory, such as one or more hard disk drives, and/or a volatile memory, such as random-access memory (RAM). System 20 typically comprises a profile database 28, such as a relational or non-relational database, as described in more detail hereinbelow with reference to FIG. 2. System 20 comprises appropriate software for carrying out the functions prescribed by the present invention. This software may be downloaded to the system in electronic form over a network, for example, or it may alternatively be supplied on tangible media, such as CD-ROM.

Network environment 10 further includes one or more online message servers 30, which host electronic discussion forums, message boards, articles published online, and/or recommendations published online. Typically, message servers 30 are operated by entities other than the entity that operates sentiment analysis and prediction system 20. The message servers allow contributors to post online messages, and other users to view and/or download the posted messages, typically using the HTML protocol. Message servers 30 typically comprise Web servers and appropriate data stores for storing the posted messages.

Network environment 10 also includes at least one market information server 32, which provides market information regarding financial instruments, such as publicly-traded equity securities (e.g., common stocks), debt securities (e.g., bonds), exchange-traded funds (ETFs), commodities, and derivatives. The market information typically includes a symbol for the financial instrument, price information, and trading volume information. Typically, market information server 32 is operated by an entity other than the entity that operates sentiment analysis and prediction system 20. Market information server 32 typically comprises a Web server and an appropriate data store for storing the market information.

A plurality of users 40 use respective workstations 42, such as a personal computers, to remotely access sentiment analysis and prediction system 20 and online message servers 30 via a wide-area network (WAN) 44, such as the Internet. Typically, some of users 40 access only one or more of online message servers 30, some access only sentiment analysis and prediction system 20, and some access both the message servers and the sentiment analysis and prediction system. A web browser running on each workstation 42 typically communicates with web servers of system 20 and message servers 30. Each of workstations 42 comprises a central processing unit (CPU), system memory, a non-volatile memory such as a hard disk drive, a display, input and output means such as a keyboard and a mouse, and a network interface card (NIC). Alternatively, instead of workstations, users 40 use other devices, such as portable and/or wireless devices, to access the servers. In addition, sentiment analysis and prediction system 20 remotely accesses market information server 32, either via WAN 44, or another communication link.

Reference is made to FIG. 2, which is a schematic block diagram illustrating components of sentiment analysis and prediction system 20, in accordance with an embodiment of the present invention. System 20 typically comprises a web crawler 50, a market information collector 52, a sentiment engine 54, a message clustering engine 56, a summary generation module 58, a profile database 28, a model generation engine 60, a model refiner 62, a market prediction engine 64, a message and author filtering engine 66, a report generator 68, and/or a web server 70. Each of these components is described in more detail hereinbelow.

### The Web Crawler and the Market Information Collector

In an embodiment of the present invention, web crawler 50 generally constantly scans electronic sources of information, such as online message servers 30 (FIG. 1), to identify online messages containing information regarding financial instruments. Such messages include, but are not limited to, articles posted on the Internet, content from message boards and discussion forums, blog postings and on-line newspapers, as described hereinabove.

Market information collector 52 receives objective quantitative data regarding financial instruments. For some applications, collector 52 receives the data by generally constantly scanning electronic sources of information, such as market information server 32 (FIG. 1), to identify the objective quantitative data. Such data includes, but is not limited to, financial instrument prices and price changes, trading volumes, interest rates, and sales and profits figures. Financial instrument prices, trade volumes, and even financial reports (e.g., revenues and profits) regarding companies are regularly posted in various forums and are widely accessible, in standard formats, such as HTML, XML, and RSS feeds. For some applications, market information collector 52 scans publicly-accessible web sites to find such information. Alternatively, the information is provided by a proprietary and/or for-pay service.

### The Sentiment Engine

In an embodiment of the present invention, sentiment engine 54 processes the messages obtained by web crawler 50. The sentiment engine analyzes the content of each message to produce a list of one or more financial instruments that the message discusses. For each identified financial instrument, the sentiment engine generates a sentiment score of the message regarding the financial instrument, e.g., having a value of between 0 and 1, or 0 and 100. Lower sentiment scores indicate that the message expresses a negative opinion regarding the financial instrument, and higher sentiment scores indicate a positive opinion regarding the financial instrument.

For example, assume that a message contains the following text: “X Corporation (XCOR) is a lousy company, and I would never buy their stock. Their sales are going to drop, and they are wasting money. Y Corporation (YCOR) would be a much better choice for investment, and I am sure their stock would go up!” This message expresses sentiments regarding two securities (the publicly-traded stocks of X Corporation and Y Corporation, represented by stock tickers XCOR and YCOR, respectively), and expresses a positive sentiment towards Y Corporation and a negative sentiment towards X Corporation. The analysis of the message by sentiment engine 54 thus produces two scores: a higher sentiment score for Y Corporation and a lower sentiment score for X Corporation.

For some applications, sentiment engine 54 processes message sentiment using a commercially-available sentiment engine, such as the SentiMetrix product (SentiMetrix, Inc., Bethesda, Md., USA) or the Gavagai product (Gavagai AB, Stockholm, Sweden). For some applications, sentiment engine 54 implements one or more machine learning techniques, such as support vector machine (SVM) learning techniques or the naive Bayes classifier (for example, using techniques in the articles by Domingos et al. and Rish mentioned hereinbelow), optionally with manual calibration. For some applications, sentiment engine 54 is configured to receive a list of terms (e.g., synonyms or words) that strongly relate to a certain financial instrument or corporation, and to use these terms to help identify key subjects in messages.

### The Message Clustering Engine

In an embodiment of the present invention, message clustering engine 56 receives the raw messages collected by web crawler 50, and categorizes the messages by the main topic discussed in each of the messages. For example, assume the message clustering engine receives five messages that mention the X Corporation, the first three of which mention that X Corporation's sales are rising, and the last two of which discuss X Corporation's new cellular phone. The message clustering engine would generate two categories for these messages: a “sales” topic and a “new cellular phone” topic. The first three messages would be associated with the sales topic, and the last two messages would be associated with the cellular phone topic. For some applications, message clustering engine 56 uses a list of terms (e.g., synonyms or words) to categorize the messages. Alternatively or additionally, the engine uses latent semantic analysis (LSA) to categorize the messages, as is known in the art. For some applications, message clustering engine 56 uses clustering techniques described hereinbelow as being used by the authoring filtering engine and/or the message filtering engine of engine 66.

In an embodiment of the present invention, message clustering engine 56 is configured to infer sentiments of a particular first author regarding a financial instrument of a corporation even when the first author has posted a message that implicitly but not explicitly indicates a sentiment regarding the financial instrument. The message clustering engine infers the first author's sentiment regarding the financial instrument by identifying other second authors who have posted messages regarding the same topic(s), and have expressed opinions similar to those of the first author regarding the financial instrument or another aspect of the corporation. For example, the second authors and the first author may have expressed similar sentiments regarding the particular financial instrument at approximately the same time in the past. The system makes the assumption that the first author would currently share the sentiments of these second authors, particularly if the first author and second authors express similar opinions in their most recent messages regarding an aspect of the corporation other than its financial instrument. For some applications, the aspect of the corporation is reflected as a topic regarding the corporation, as described herein. For some applications, the engine identifies such shared sentiments by comparing the stored structured summaries of messages posted by the authors. Alternatively or additionally, the engine identifies such sentiments using sentiments the first author posts regarding other financial instruments that have characteristics in common with the particular financial instrument. For some applications, sentiment engine 54 alternatively or additionally performs these inference techniques.

For example, assume that two first authors, Alice and Bob, post respective messages regarding similar first topics, e.g., both Alice's and Bob's messages regarding X Corporation discuss its search technology. Further assume that two other second authors, Charlie and David, also post respective messages regarding similar second topics, e.g., about the constant crashing of X Corporation's website. Also assume that many reports have been posted during the past day regarding the crashing of X Corporation's website in the past day (e.g., 60% of all the messages posted in the past day regarding X corporation regard such crashing). Still further assume that Alice usually shares Bob's sentiments, and Charlie usually shares David's sentiments. Alice had posted a very negative sentiment regarding X Corporation, and Charlie had posted a very positive sentiment (for example, Charlie thinks the website crashing has been resolved). Although David has not published an opinion recently, engine 56 infers that David has a positive sentiment regarding X Corporation despite Alice's message, because Charlie and David usually post messages regarding topics different from those of Alice's messages, and because David usually agrees with Charlie regarding today's hot topic of crashes. Engine 56 finds that most of the recently posted messages regard the topic that Charlie (and David) usually discuss, and thus infers that David would have a positive sentiment, because David generally expresses sentiments similar to those of Charlie (and not to those of Alice).

For some applications, message clustering engine 56 is configured to infer sentiments using augmented or constrained single value decomposition (SVD) techniques (for example, using techniques described in Sarwar B et al., “Incremental Singular Value Decomposition Algorithms for Highly Scalable Recommender Systems,” Fifth International Conference on Computer and Information Science, 2002), and/or using non-negative matrix factorization (NNMF).

### The Summary Generation Module and the Profile Database

In an embodiment of the present invention, summary generation module 58 receives (a) each message (from sentiment engine 54, message clustering engine 56, web crawler 50, or a database storing the raw messages), (b) the message sentiment information provided by sentiment engine 54, and, optionally, (c) the clustering information generated by message clustering engine 56. The summary generation module uses the message sentiment information and, optionally, as described below, message clustering information for each message to generate one or more structured summaries of the message. The module generates a separate structured message summary for each financial instrument about which the message expresses a sentiment. The structured summary is a concise multi-attribute description of the sentiment expressed in the message regarding a particular financial instrument. Each attribute of the structured summary comprises a numerical value, an enumerated attribute (selected from a list of several possible values for each attribute), or a free text field.

(The structured summaries may be thought of as “sketches,” as the term is understood in the computer science art. For example, see Gionis A et al., “Similarity Search in High Dimensions via Hashing,” Proceedings of the 25th Very Large Database (VLDB) Conference (1999), and Indyk P et al., “Approximate Nearest Neighbors Towards Removing the Curse of Dimensionality,” Proceedings of 30th Symposium on Theory of Computing (1998).)

Each structured summary typically includes one or more of the following attributes:
the sentiment expressed in the message regarding the particular financial instrument (expressed as a score (i.e., a numerical value) within a certain range of values, e.g., between 0 and 1, or 0 and 100);
a confidence score for the sentiment, as described hereinbelow;
an identifier of the financial instrument (e.g., a stock symbol), which summary generation module typically receives from sentiment engine 54. Alternatively or additionally, the summary includes an identifier of the topic to which the message relates, or the stock symbol and a particular topic (e.g., frequent crashes of X Corporation's website). For some applications, the identifier includes a probability score for one or more stock symbols, e.g., MSFT/90%, AMZN/5%, for the example given immediately hereinbelow;
the date, and optionally the time, of publication of the message;
the name or pseudonym of the author of the message, if available;
the length of the message, or, if the message expresses sentiments regarding a plurality of financial instruments, the length of the portion of the message that expresses a sentiment regarding the particular financial instrument reflected in the summary;
key words of the message, as identified by message clustering engine 56. For some applications, the clustering engine identifies words that often occur in messages regarding a given company, and rarely occur in messages regarding other companies. For example, it is unlikely that messages regarding most companies would include the word “IPhone,” while messages regarding the company Google Inc. have a significant probability of including this word. In addition, for some applications, such key words (and/or topic clusters) are used by message clustering engine 56 to infer sentiments, e.g., as described hereinabove in the example including Charlie, David, Alice, and Bob;
links and/or cross-references between messages (for example, indicating that the message cites another message, or that the message is a response to another message);
indicators of clusters to which the message belongs; and/or
the number of replies the message received.

For some applications, the confidence score is calculated responsively to a number of identified synonyms or related keywords in the message and, optionally, the message length. For example, assume the following message was posted: “Microsoft® is great. I love Bill Gates, and think Windows® is the best product ever made. Vista® has an excellent user interface, and the new ribbon in Word® and Excel® is really cool. If you don't believe me, buy Bill's biography on Amazon® and see for yourself.” This message clearly expresses a positive sentiment. However, the message mentions both Microsoft and Amazon. In order to ascertain which of these entities the message discusses, the system identifies that the message mentions Microsoft, Bill Gates, Word, Excel, and Vista, all of which are included on a list of keywords associated with Microsoft (because many messages regarding Microsoft have included these keywords). In contrast, the message includes only a single keyword related to Amazon (the word “Amazon” itself). The system would thus assign a high confidence score to the message as a positive sentiment regarding the topic of Microsoft (e.g., the common stock of Microsoft Corporation), and a low confidence score to the message as a positive sentiment regarding the topic of Amazon (e.g., the common stock of Amazon.com Inc.).

The structured summaries are stored in profile database 28. The database typically indexes the summaries according to several properties, such as the identifier of the financial instrument, and/or the date of publication of the message. The database thus is able to respond to queries regarding the most recent sentiment scores expressed by each author for each financial instrument during a given time period (e.g., on a given day). For example, the profile database may return the latest sentiment score of messages author aᵢ has published regarding financial instrument A on day d.

Profile database 28 also returns the confidence score for the sentiment, which is typically used to weight the sentiment accordingly. For example, an author's negative sentiment that has a high confidence score would be weighted more than a sentiment that has a low confidence score. For some applications, a confidence threshold is used to perform this evaluation. If a given sentiment has a confidence score that is less than the threshold, the system may attempt to infer the author's view through other authors, as described hereinabove, rather than using the expressed sentiment. In other words, the system may treat the message as lacking a sentiment, rather than using this most recently expressed sentiment that has a low probability of regarding the correct topic.

### The Model Generation Engine

In an embodiment of the present invention, model generation engine 60 builds a summary profile for each financial instrument at specified times in the past. For a specified time t in the past, the model generation engine retrieves structured summaries from the profile database, and calculates a set of one or more predictor attributes xᵢ, . . . , xₙ regarding the financial instrument (for example, after inferring missing sentiments using similar authors' expressed sentiments, as described hereinabove, and/or considering hot topics as identified by the message clustering engine, as described hereinabove). These predictor attributes typically have numerical values (for example on a scale from 0 to 100, 0 indicating a negative sentiment, 50 a neutral sentiment, and 100 a positive sentiment). For example, the predictor variables may reflect the latest sentiments expressed by a plurality of authors regarding the target financial instrument. As described hereinbelow, market prediction engine 64 use values of these attributes to generate predictions regarding future market data.

In an embodiment of the present invention, model generation engine 60 uses the information stored in profile database 28, including the predictor attributes and their values, to build a mathematical prediction model for a target variable. Exemplary target variables include, but are not limited to, a price of a financial instrument, a change in a price of a financial instrument, a transaction volume of a financial instrument, a sales volume of a corporation or product, and a profit of a corporation or product. The model generation engine employs techniques from the fields of data mining, machine learning, and statistics to generate the prediction model that predicts the target variable based on the predictor attributes and their values stored in profile database 28, as described hereinabove. The prediction model is a function which maps the values of the predictor attributes available at time t (e.g., the present) to the numerical value of the target variable at time t+Δt (e.g., the future). In general, the prediction model gradually becomes more accurate as data accumulates in profile database 28.

The following Table 1 sets forth exemplary values of the exemplary attributes “sentiment score,” “confidence level,” and “topics” for a particular corporation during a particular time period (e.g., a particular day):

TABLE 1

| Author | Sentiment | Confidence | Topic(s) |
|---|---|---|---|
| A | 90 (positive) | 90% | financial reports |
| B | 20 (negative) | 80% | employees |
| C | 10 (negative) | 10% | financial reports |
| D | 80 (positive) | 80% | employees and |
| | | | financial reports |

Model generation engine 60 generates a prediction model using these attribute profiles and corresponding objective data regarding the target value for a plurality of time periods (e.g., days) in the past. For example, the engine may use tuples of the form <attribute value, stock price>, in which the price is of the stock at a time after the posting of the message from which the attribute value was derived, such as a few hours or a day afterwards.

Because of the low confidence score of the sentiment expressed by Author C, model generation engine 60 may decide to ignore this sentiment (or infer the sentiment based on the sentiments of other authors, as described hereinabove).

It is important to note that model generation engine 60 does not itself directly generate predictions regarding the future, but rather generates a method, reflected in the prediction model, for predicting the target variable based on the predictor values of the predictor attributes. For example, the model generation engine may process the information stored in profile database 28 for time t₁ to generate a prediction model f. At the time the model is generated, the profile database only contains information up to time t₁. The model f may be used later, at a time t₂>t₁, at which the profile database contains additional information that it did not contain at time t₁. When market prediction engine 64, as described hereinbelow, subsequently uses model f at time t₂, this additional information is also used.

In an embodiment of the present invention, model generation engine 60 generates the prediction model using multiple linear regression. This technique is typically appropriate when all of the values of the predictor variables are numerical quantities. Linear regression may be used, for example, to build a linear model of the future price of a target financial instrument. For example, the linear regression model may be based on weights that express the future price of the target financial instrument as a linear combination of the predictor variables (for example, the latest sentiments expressed by a plurality of authors regarding the target financial instrument). The target variable Y is predicted as a weighted linear combination of the predictor variables x₁, . . . , xₙ, such that Y=β₀+β₁X₁+β₂X₂+ . . . +βₙXₙ. The weights βᵢ of the predictor variables in such a model are based on past experience, using a linear regression process, as is known in the mathematical arts (see, for example, Draper, N. R. and Smith, H. Applied Regression Analysis Wiley Series in Probability and Statistics (1998), and Kaw, Autar; Kalu, Egwu (2008), Numerical Methods with Applications (1st ed.)).

In an embodiment of the present invention, model generation engine 60 generates the prediction model using logistic regression (a non-linear modeling technique). This technique predicts the probability of a future change in a target variable, such as a price of a financial instrument. The target probability Y may be expressed as

$$\begin{matrix}Y = f ( z ) \\ = \frac{1}{1 + {e}^{- {z}^{′}}}\end{matrix}$$

in which z=β₀+β₁X₁+β₂X₂+ . . . +βₙXₙ. The weights βᵢ are learned from past experience (for example, using techniques described in Joseph M., Logistic Regression Models, Chapman & Hall/CRC Press (2009), or Hosmer, David W.; Stanley Lemeshow, Applied Logistic Regression, 2nd ed., New York; Chichester, Wiley (2000)). Alternatively, engine 60 uses another non-linear modeling technique.

Further alternatively, the model generation engine generates the prediction model using linear discriminant analysis (for example, using techniques described in McLachlan G. J., Discriminant Analysis and Statistical Pattern Recognition, Wiley-Interscience; New Ed edition (Aug. 4, 2004), and/or Friedman, J. H., “Regularized Discriminant Analysis,” Journal of the American Statistical Association (1989)).

In an embodiment of the present invention, model generation engine 60 generates the prediction model according to enumerated values, which may be ordered. For example, the enumerated values for the change in price of a financial instrument may include “low,” “medium,” “high,” and “extreme.” Because these enumerated values are ordered, they are not merely strings.

The model generation engine may build the model using, for example, one or more of the following techniques:
decision trees, e.g., using techniques described in V. Berikov, A. Litvinenko, “Methods for statistical data analysis with decision trees,” Novosibirsk, Sobolev Institute of Mathematics (2003), and/or L. Breiman, J. Friedman, R. A. Olshen and C. J. Stone, “Classification and regression trees,” Wadsworth (1984);
random forests, e.g., using techniques described in Ho, Tin Kam, “Random Decision Forest,” Proc. of the 3rd Int'l Conf. on Document Analysis and Recognition, Montreal, Canada, Aug. 14-18, 1995, p. 278-282, and/or Ho, Tin Kam, “The Random Subspace Method for Constructing Decision Forests,” IEEE Trans. on Pattern Analysis and Machine Intelligence 20 (8), 832-844 (1998);
the naive Bayes classifier, e.g., using techniques described in Domingos, Pedro & Michael Pazzani, “On the optimality of the simple Bayesian classifier under zero-one loss,” Machine Learning, 29:103-137 (1997), and/or Rish, Irina, “An empirical study of the naive Bayes classifier,” IJCAI 2001 Workshop on Empirical Methods in Artificial Intelligence (2001)
an artificial neural network, e.g., using techniques described in Gurney, K. (1997) An Introduction to Neural Networks London: Routledge, and/or Haykin, S. (1999) Neural Networks: A Comprehensive Foundation, Prentice Hall;
a support vector machines, e.g., using techniques described in Nello Cristianini and John Shawe-Taylor. An Introduction to Support Vector Machines and other kernel-based learning methods. Cambridge University Press, 2000, and/or Huang T.-M., Kecman V., Kopriva I. (2006), Kernel Based Algorithms for Mining Huge Data Sets, Supervised, Semi-supervised, and Unsupervised Learning, Springer-Verlag, Berlin, Heidelberg;
a clustering algorithm such as K-nearest-neighbor, e.g., using techniques described in Belur V. Dasarathy, editor (1991) Nearest Neighbor (NN) Norms: NN Pattern Classification Techniques;
a Bayesian network, e.g., using techniques described in I. Ben-Gal (2007), Bayesian Networks, in F. Ruggeri, R. Kenett, and F. Faltin (editors), Encyclopedia of Statistics in Quality and Reliability, John Wiley & Sons, and/or Enrique Castillo, José Manuel Gutiérrez, and Ali S. Hadi (1997). Expert Systems and Probabilistic Network Models. New York: Springer-Verlag; or
a hidden Markov model, e.g., using techniques described in Olivier Cappé, Eric Moulines, Tobias Rydén (2005). Inference in Hidden Markov Models. Springer, and/or Kristie Seymore, Andrew McCallum, and Roni Rosenfeld. Learning Hidden Markov Model Structure for Information Extraction. AAAI 99 Workshop on Machine Learning for Information Extraction, 1999.

In an embodiment of the present invention, the prediction model comprises a multilayer perceptron, a type of a feed-forward artificial neural network known in the art, such as described, for example, in Haykin, Simon (1998), Neural Networks: A Comprehensive Foundation (2 ed.). Prentice Hall. For some applications, model generation engine 60 trains the model to predict the prices of financial instruments one day following the publication of messages. For example, a training point may comprise the most recent sentiments of all the authors regarding the target financial instrument on day d and the relative change in the financial instrument price on the following day d+1. Given p_{d}, the price of a financial instrument on day d, and p_{d+1}, the price on the following day d+1, the relative change in the price is (p_{d+1}−p_{d})/p_{d}.

For some applications, model generation engine 60 generates a plurality of prediction models using different modeling techniques, and combines the models to provide more accurate predictions. For example, the engine may combine the models using known boosting or bagging techniques.

In an embodiment of the present invention, model prediction engine 60 generates the prediction model at least in part responsively to the clusters generated by message clustering engine 56. For some applications, engine 60 ascertains respective levels of influence of topics on the target value. The engine assigns weights in the prediction model to the sentiments expressed in each message based in part on the level of influence of the topic(s) discussed in the message. For example, assume that in the past a topic regarding new cell phones strongly influenced the price of financial instrument, but a topic regarding increasing sales levels did not strongly influence the price. The prediction model thus would weight messages in regarding these topics accordingly. Also for example, assume that a certain author tends to be correct when he expresses negative sentiment regarding financial reports, but is rarely correct when he expresses a positive sentiment regarding companies' technology. Model prediction engine 60 thus weights this information accordingly.

### The Model Refiner

The processes carried out by model generation engine 60 in order to build the prediction model may be computationally intensive. In an embodiment of the present invention, the model generation engine generates a full new model only periodically, such as once per week or once per day. In order to reduce inaccuracies in the model that may occur between generations of the full model, model refiner 62 more frequently incrementally refines the model, such as once per second, minute, or hour, as new messages and/or changes in target financial instrument values are received. Although the resulting refined model is not as accurate as an entirely new model would be, the model refiner requires fewer computational resources, and still generally substantially improves the predictive power of the model. In another embodiment of the present invention, system 20 does not comprise model refiner 62.

In an embodiment of the present invention, model refiner 62 refines the prediction model f=f(x₁, . . . , Xₙ) (assuming X₁, . . . , Xₙ are the predictor variables) generated by model generation engine 60 to generate a refined model f=f(X₁, . . . , Xₙ) by:
generating a new incremental prediction model fᵣ fᵣ(X₁, . . . , Xₙ) based only on incremental information that has been added to profile database 28 since prediction model f was last generated by model generation engine 60. Model refiner 62 generates the incremental prediction model using the same technique(s) that model generation engine 60 used to generate prediction model f. Because incremental prediction model fᵣ is based on a substantially smaller set of data than prediction model f (just the most recently added information since the most recent full model was generated), fᵣ is generated in substantially less time than would be required to generate an entirely new prediction model f; and
setting the refined model f′ equal to a weighted average of the predictions generated by f and fᵣ. For example, f(X₁, . . . , Xₙ)=a f(X₁, . . . , Xₙ)+(1−α)·fᵣ(X₁, . . . , Xₙ). Typically, relatively high values of α are used to more heavily weight prediction model f, which is based on greater experience, although it reflects less recent information.

### The Market Prediction Engine

In an embodiment of the present invention, market prediction engine 64 is configured to predict future market behavior, which is typically represented as a target variable. The market prediction engine uses the mathematical prediction model generated by model generation engine 60, and, optionally, refined by model refiner 62, as described hereinabove.

For some applications, market prediction engine 64 attempts to use the predictor attributes available from the summary profiles at time t to generate a prediction about a certain variable y at time t′=t+Δt. For example, y may be the price of the financial instrument (e.g., a publicly-traded common stock) of a certain corporation at time t′, or the trading volume at time t′. For a certain author a^{j}, let m^{j}ₜ represent the latest message that author a^{j} has written regarding the target financial instrument at time t. For example, the predictor attribute may comprise the score s^{j}ₜ that sentiment engine 54 has given m^{j}ₜ. Thus, given k authors a₁, . . . , aₖ, at time t, k predictor attributes s¹ₜ, . . . , s^{k}ₜ are available. (These scores consider only the latest message posted by each author. Alternatively, the m latest such messages at time t are considered to obtain a different score.) Additional exemplary predictor attributes include, but are not limited to, the lengths of each of the messages, the number of responses posted to each of the messages, and a function of a plurality of predictor attributes.

Given the predictor attributes xᵢ, . . . , xₙ for a certain financial instrument, the concrete values of these attributes at time t are denoted x^{t}ᵢ, . . . , x^{t}ₙ. (x^{t}ᵢ, . . . , x^{t}ₙ) is denoted as the predictor profile pt for the financial instrument at time t. The profile database provides p^{t} for any time t in the past.

### The Message and Author Filtering Engine

In an embodiment of the present invention, message and author filtering engine 66 prioritizes the recent messages gathered by web crawler 50 according to the relative importance of the messages. Engine 66 determines which authors and/or messages to include in reports, and sends the prioritization information to report generator 68, described hereinbelow, for generation of a report for users that contains the most important recent messages.

For some applications, message and author filtering engine 66 comprises an author filtering engine. The author filtering engine identifies the authors who post the most important messages. The author filtering engine may use the prediction model generated by model prediction engine 64 to calculate author importance (for example, in linear regression, the weights of the authors in the generated model reflect their importance), or the author filtering engine may calculate author important on its own (e.g., using some of the techniques described hereinabove).

This prioritization is based on one or more criteria. For some applications, one such criterion is the correlation between the opinions of each of the authors and the actual objective market information that occurred after the posting of the author's messages. For example, assume a first author posts messages with a positive sentiment regarding a certain financial instrument (for example, that the price will rise), and a second author posts messages with a negative sentiment regarding the financial instrument (for example, that the price will drop). If the objective market information indicates that the price actually rose after the two authors had posted their respective messages, the author filtering engine assigns a higher priority to the first author than to the second author. Another criterion is the influence the author's messages have on other authors.

For some applications, the author filtering engine identifies authors whose messages contribute strongly to the predictors for target variables using linear regression (in a similar manner to the prediction performed by model generation engine 60, described hereinabove), and orders the authors according to the weights learned for the regression. Alternatively or additionally, the author filtering engine identifies the most important authors using ANOVA techniques (for example, using techniques described in King, Bruce M., Minium, Edward W. (2003), Statistical Reasoning in Psychology and Education, Fourth Edition. Hoboken, N.J.: John Wiley & Sons, Inc., and/or Lindman, H. R. (1974). Analysis of variance in complex experimental designs. San Francisco: W. H. Freeman & Co.), or using Principal Component Analysis (PCA) (for example, using techniques described in Jolliffe I. T. Principal Component Analysis, Series: Springer Series in Statistics, 2nd ed., Springer, N.Y., 2002; C. Ding and X. He. “K-means Clustering via Principal Component Analysis”. Proc. of Int'l Conf. Machine Learning (ICML 2004), pp 225-232. July 2004; and/or Reenacre, Michael (1983), Theory and Applications of Correspondence Analysis, London: Academic Press). For some applications, the author filtering engine uses clustering techniques described hereinabove as being used by the message filtering engine and/or message clustering engine 56.

For some applications, message and author filtering engine 66 comprises a message filtering engine. The message filtering engine identifies the messages of the top ranked authors, as identified by the author filtering engine, that pertain to the target variable.

For some applications, the message filtering engine identifies topics in the messages posted within a certain time frame, and classifies the messages according to these topics. For some applications, the message filtering engine partitions the messages into clusters using Latent Semantic Analysis (LSA, PLSA), Principal Component Analysis (PCA) (for example, using techniques described in the above-mentioned references regarding PCA), and/or Latent Dirichlet Allocation (LDA) (for example, using techniques described in Blei, David M.; Ng, Andrew Y.; Jordan, Michael I. (January 2003). “Latent Dirichlet allocation”. Journal of Machine Learning Research 3: pp. 993-1022; and/or Girolami, Mark; Kaban, A. (2003). “On an Equivalence between PLSI and LDA” in Proceedings of SIGIR 2003., New York: Association for Computing Machinery). For some applications, the message filtering engine uses clustering techniques described hereinabove as being used by the author filtering engine and/or message clustering engine 56.

For some applications, after the message filtering engine clusters the messages according to topics, message and author filtering engine 66 identifies, within each topic cluster, the messages posted by the most important authors, as identified by the author filtering engine, as described hereinabove. Engine 66 sends these messages to report generator 68, described hereinbelow, for generation of a report for users that contains these most important messages. For example, assume that a collection of messages posted within a one-week or one-day period includes ten messages discussing a change in the management of a company, five messages discussing the latest product that the company began manufacturing, and twenty messages regarding a new competitor of the company. The message filtering engine automatically partitions the messages into three clusters corresponding to the these three topics of the messages, typically without using a predefined set of rules regarding how to perform the partitioning. Then the system displays the messages posted by the most important author in each cluster.

For some applications, message and author filtering engine 66 identifies important topics that have strongly influenced the target variables in the past.

### The Report Generator

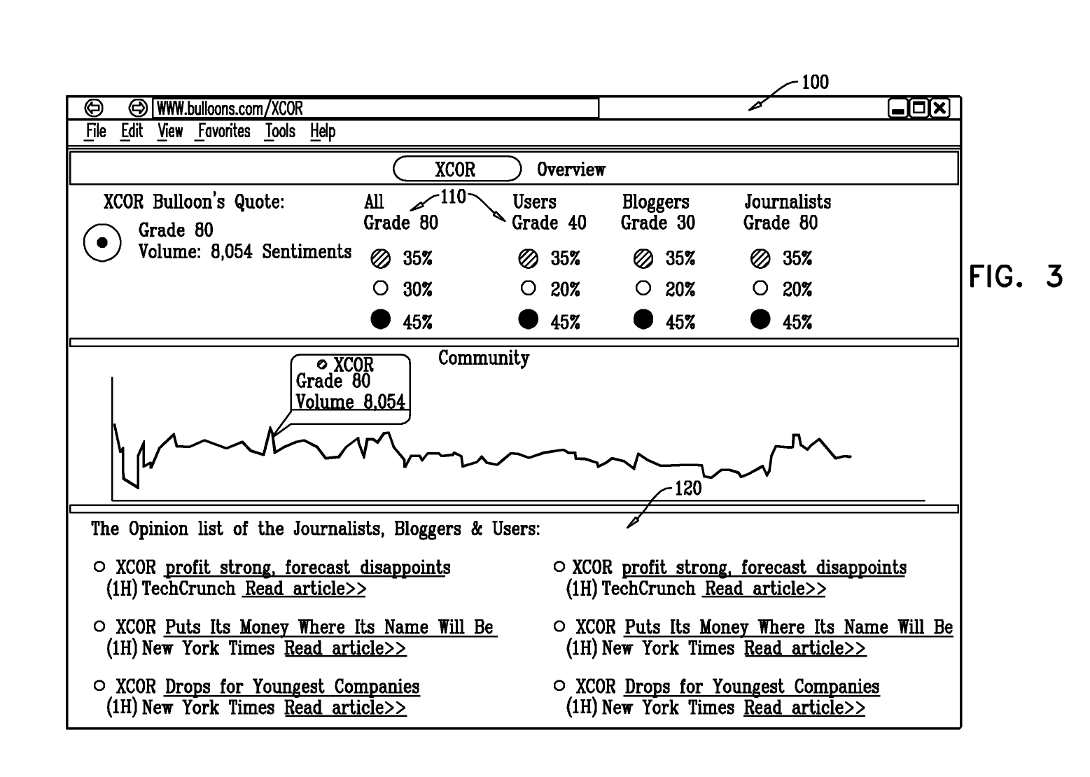

Reference is made to FIG. 3, which is an exemplary screen shot showing an exemplary report 100 generated by report generator 68, in accordance with an embodiment of the present invention. For some applications, report generator 68 receives predictions generated by market prediction engine 64, and formats the predictions for display to users 40 of system 20 (typically on a web browser of each user's respective workstation 42).

For some applications, report 100 includes indicators 110 of the future value of the target value generated by market prediction engine 64. Separate indicators may be provided for different categories of authors, such as users 40, journalists, and analysts. The indicators may include overall averages, as well as indications of the distribution of values of the indicators.

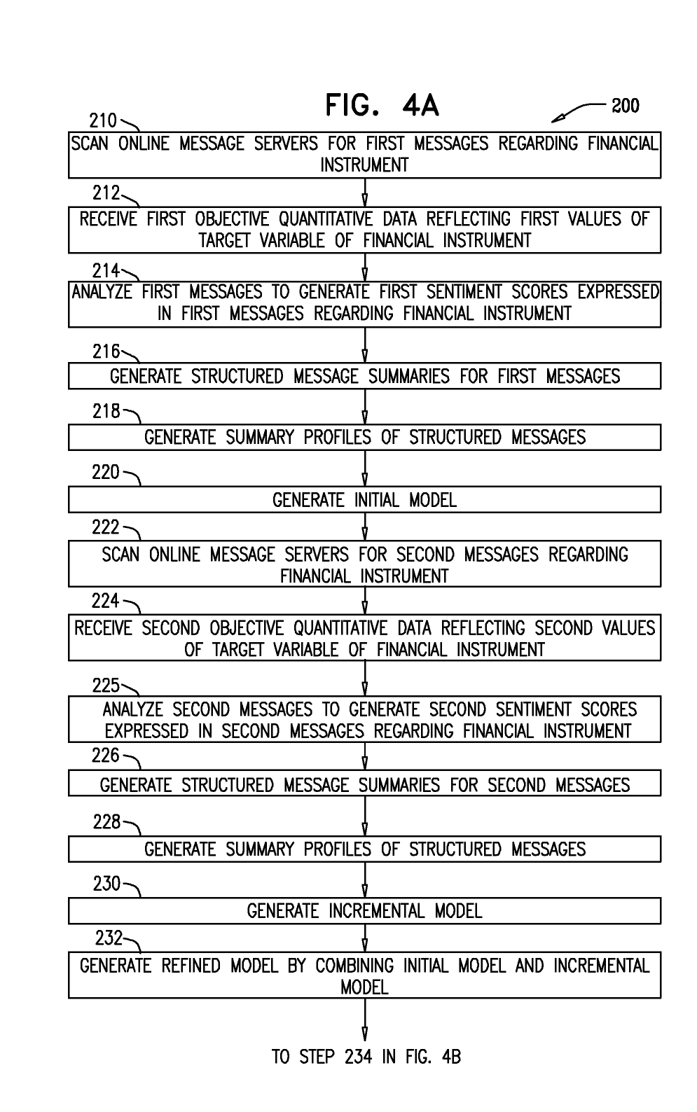

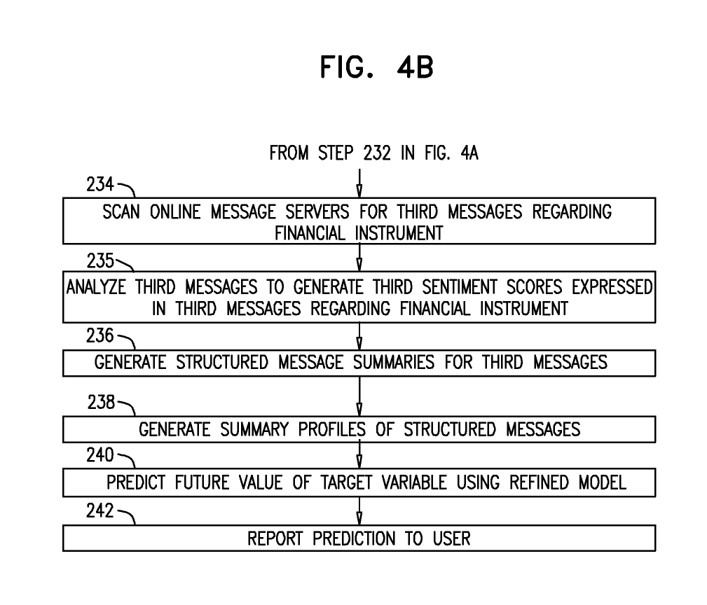

The indicators may comprise, for example, a predicted percentage change in the value of the target variable, an absolute change in the target value, a score that reflects the predicted target value, or another graphical, textual, and/or numeral reflection of the predicted value of the target variable. For some applications, as shown in FIGS. 4A-B, indicators 110 comprise scores that reflect a percentage change in the value of the target variable. For example, the score may be calculated using the equation s=ax+c, in which s represents the score, a is a coefficient (e.g., 12.5), x is the predicted change in the value of the target variable (e.g., expressed as a percentage), and c is a constant (e.g., 50). Using these values, a predicted increase in price of 2% would be reflected as a score of 75, and a predicted decrease in price of 1% would be reflected as a score of 37.5. In this example, if the maximum and minimum percentage changes are capped at 4%, the score will range between 0 and 100.

For some applications, report generator 68 receives author and/or message prioritization information generated by message and author filtering engine 66, as described hereinabove, and formats the prioritization information for display to users 40 of system 20 (typically on a web browser of each user's respective workstation 42). The report generator typically more prominently displays messages 120 posted by authors found to be more important by message and author filtering engine 66, or topics found to be more important by engine 66.

Report 100 may contain additional conventional information, such as at least one stock chart 122, as is well known in the art.

For some applications, report generator 68 conveys the generated reports to user 40 via a web server 70, as is known in the art. The web server typically comprises a communication interface, a central processing unit (CPU), and a memory, which typically comprises a non-volatile memory, such as one or more hard disk drives, and/or a volatile memory, such as random-access memory (RAM). Alternatively or additionally, the report generator conveys the generated reports to the users via another communication medium, such as e-mail, SMS, a telephone call, and/or wirelessly.

Reference is made to FIGS. 4A-B, which are a flow chart that schematically illustrates a method 200 for analyzing sentiments to predict market variables, in accordance with an embodiment of the present invention. Method 200 begins at a message scanning step 210, at which web crawler 50 (FIG. 2) scans online message servers 30 (FIG. 1) to identify a plurality of first messages posted during a first period of time. The first messages contain information regarding a financial instrument or other target object, such as described hereinbelow. At an objective data receipt step 212, market information collector 52 (FIG. 2) receives first objective quantitative data reflecting respective first values of a target variable associated with the financial instrument, such first values measured after the respective first messages are posted.

At a sentiment processing step 214, sentiment engine 54 analyzes the first messages to generate respective first sentiment scores reflecting respective sentiments expressed in the first messages regarding the financial instrument. Lower sentiment scores indicate that the message expresses a negative opinion regarding the financial instrument, and higher sentiment scores indicate a positive opinion regarding the financial instrument.

At a message summary generation step 216, summary generation module 58 receives each of the first messages, and generates a structured message summary for each of the first messages. Module 58 stores these structured summaries in profile database 28. At a summary profile generation step 218, model generation engine 60 calculates a set of one more predictor attributes and their values, using the structured message summaries.

Model generation engine 60 analyzes the first sentiment scores stored in the structured message summaries, and the associated first values of the target variable, to generate an initial, full mathematical prediction model for the target variable, at an initial model generation step 220. Typically, engine 60 generates such a full model only periodically, as described hereinabove.

At a second message scanning step 222, web crawler 50 continues to scan online message servers 30 to identify one or more second messages posted during a second period of time after the first period of time, i.e., after the initial model has been generated. At a second objective data receipt step 224, market information collector 52 receives second objective quantitative data reflecting respective second values of a target variable associated with the financial instrument, such second values measured after the respective second messages are posted.

At a second sentiment processing step 225, sentiment engine 54 analyzes the second messages to generate respective second sentiment scores reflecting respective sentiments expressed in the second messages regarding the financial instrument. Summary generation module 58 generates structured message summaries for the second messages, at a second message summary generation step 226. Module 58 stores these structured summaries in profile database 28. At a second summary profile generation step 228, model generation engine 60 calculates a set of one more predictor attributes and their values, using the structured message summaries.

In order to refine the initial, full model prediction model, model generation engine 60 or model refiner 62 analyzes the second sentiment scores stored in the structured message summaries, and the associated second values of the target variable, to generate an incremental mathematical prediction model for the target variable, at an incremental model generation step 230. Engine 60 or model refiner 62 generates the incremental model using the same modeling techniques used to generate the initial model at initial model generation step 220. At a refined model generation step 232, model refiner 62 generates a refined mathematical prediction model by combining the initial prediction model with the incremental prediction model, such as described hereinabove with reference to FIG. 2. For some applications, model refiner 62 sets the refined model equal to a weighted average of the predictions generated by the initial model and the incremental model.

At a third message scanning step 234, web crawler 50 continues to scan online message servers 30 to identify one or more third messages posted during a third period of time after the second period of time, i.e., after the refined model has been generated. At a third sentiment processing step 235, sentiment engine 54 analyzes the third messages to generate respective third sentiment scores reflecting respective sentiments expressed in the third messages regarding the financial instrument. Summary generation module 58 generates structured message summaries for the third messages, at a third message summary generation step 236. Module 58 stores these structured summaries in profile database 28. At a third summary profile generation step 238, model generation engine 60 calculates a set of one more predictor attributes and their values, using the structured message summaries.

At a market prediction step 240, market prediction engine 64 uses the refined prediction model, with the values of the third predictor attributes as input thereto, to predict a future value of the target variable. At a reporting step 242, report generator 68 reports, to one or more users 40, an indicator of the future value of the target variable in association with an identifier of the financial instrument, such as the name of the financial instrument, the ticker of the instrument, and/or the name of the corporation that issued or is associated with the financial instrument. The indicator may comprise, for example, a predicted percentage change in the value of the target variable, an absolute change in the target value, a score that reflects the predicted target value (such as described hereinabove with reference to report generator 68), or another graphical, textual, and/or numeral reflection of the predicted value of the target variable.

For some applications, system 20 subsequently receives the actual future value of the target variable, and uses the this value and the associated sentiment score(s) when generating a new prediction model at step 220 and/or refining a prediction model at steps 230 and 232.

In an embodiment of the present invention, sentiment analysis and prediction system 20 tests an advertisement of a sales and/or marketing campaign, by predicting how much traffic the advertisement would attract. The test advertisement is shown to a plurality of visitors to a certain website, and the system measures how many of the visitors click on the advertisement. To predict the effectiveness of the advertisement, viewers are asked to express their opinions regarding the advertisement. The system analyzes the sentiments of the viewers (based on the messages they generated), and identifies the key issues the viewers have raised regarding the advertisement, and the general sentiment of the viewers.

In an embodiment of the present invention, sentiment analysis and prediction system 20 is used to improve product manufacturing quality. Upon the introduction of a product to the market (e.g., a tangible product, such as a cellular telephone), opinions are solicited from users of the product, and/or opinions are collected from online messages posted by users of the product. The system identifies sentiments of the users, and finds the most important issues correlated with high or low sentiments. The report includes positive sentiments (product strengths) and negative sentiments (problems that need to be resolved). Once this analysis is performed over several cycles to improve the product, the system may also use the objective data of sales figures to predict how many units would be sold in the future.

Embodiments of the present invention described herein can take the form of an entirely hardware embodiment, an entirely software embodiment or an embodiment including both hardware and software elements. In an embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium.

Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Typically, the operations described herein that are performed by sentiment analysis and prediction system 20 transform the physical state of memory 26, which is a real physical article, to have a different magnetic polarity, electrical charge, or the like depending on the technology of the memory that is used.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the invention.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the C programming language or similar programming languages.

It will be understood that each block of the flowchart shown in FIGS. 4A-B, and combinations of blocks in the flowchart, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart blocks.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method comprising:
scanning online message servers to identify a plurality of first messages posted during a first period of time, which first messages contain information regarding a financial instrument;
receiving first objective quantitative data reflecting respective first values of a target variable associated with the financial instrument, such first values measured after the respective first messages are posted;
analyzing the first messages to generate respective first sentiment scores reflecting respective sentiments expressed in the first messages regarding the financial instrument;
generating an initial mathematical prediction model for the target variable by analyzing the first sentiment scores and the associated first values of the target variable;
scanning the online message servers to identify one or more second messages posted during a second period of time after the first period of time, which second messages contain information regarding the financial instrument;
receiving second objective quantitative data reflecting respective second values of the target variable associated with the financial instrument, such second values measured after the second messages are posted;
analyzing the second messages to generate respective second sentiment scores reflecting respective sentiments expressed in the second messages regarding the financial instrument;
generating an incremental mathematical prediction model for the target variable by analyzing the second sentiment scores and the associated second values of the target variable;
generating a refined mathematical prediction model by combining the initial prediction model with the incremental prediction model;
scanning the online message servers to identify a plurality of third messages posted during a third period of time after the second period of time, which third messages contain information regarding the financial instrument;
analyzing the third messages to generate respective third sentiment scores reflecting respective sentiments expressed in the third messages regarding the financial instrument;
predicting a future value of the target variable using the refined prediction model with the third sentiment scores as input thereto; and
reporting, to a user, an indicator of the future value of the target variable in association with an identifier of the financial instrument.

2. The method according to claim 1, wherein generating the incremental and refined prediction models comprises generating a plurality of incremental and refined prediction models based on the initial prediction model.

3. The method according to claim 2, wherein generating the plurality of incremental and refined prediction models comprises generating a new one of the incremental models and a new one of the refined models upon the posting of each of the second messages.

4. The method according to claim 1, wherein combining the initial prediction model with the incremental prediction model comprises setting the refined prediction model equal to a weighted average of predictions generated by the initial prediction model and predictions generated by the incremental prediction model.

5. The method according to claim 1, wherein analyzing the first messages to generate the respective first sentiment scores comprises generating and storing respective structured summaries of the first messages, which summaries comprise the respective first sentiment scores and an identity of the financial instrument, and do not comprise complete textual contents of the respective first messages, and wherein analyzing the first sentiment scores comprises reading the first sentiment scores from the respective structured summaries.

6. The method according to claim 1, wherein the financial instrument comprises a financial instrument of a corporation, and wherein analyzing the first messages to generate the respective first sentiment scores comprises analyzing one of the first messages posted by a first author to generate a respective one of the first sentiment scores reflecting a respective one of the sentiments implicitly but not explicitly expressed by the first author in the first message regarding the financial instrument, by inferring the first author's sentiment regarding the financial instrument responsively to: (a) a first similarity between (i) a first previous sentiment expressed by the first author in a previous message and (ii) one or more second previous sentiments expressed by one or more respective second authors in one or more previous messages, and (b) a second similarity between (i) a first current sentiment expressed by the first author in the first message regarding an aspect of the corporation other than the financial instrument and (ii) one or more second current sentiments expressed by the one or more respective second authors in respective ones of the first messages regarding the aspect of the corporation.

7. The method according to claim 1, wherein generating the initial prediction model comprises:
identifying one or more topics discussed in respective first messages;
ascertaining respective levels of influence of the topics on the first values of the target variable; and
assigning respective weights in the initial prediction model to the respective sentiments expressed in the first messages based in part on the respective levels of influences of the topics discussed in the respective first messages.

8. A computer system for use with online message servers, the system comprising:
a web crawler, which is configured to scan the online message servers to identify: (a) a plurality of first messages posted during a first period of time, which first messages contain information regarding a financial instrument, (b) one or more second messages posted during a second period of time after the first period of time, which second messages contain information regarding the financial instrument, and (c) a plurality of third messages posted during a third period of time after the second period of time, which third messages contain information regarding the financial instrument;
a market information collector, which is configured to receive: (a) first objective quantitative data reflecting respective first values of a target variable associated with the financial instrument, such first values measured after the respective first messages are posted, and (b) second objective quantitative data reflecting respective second values of the target variable associated with the financial instrument, such second values measured after the second messages are posted;
a sentiment engine, which is configured to analyze: (a) the first messages to generate respective first sentiment scores reflecting respective sentiments expressed in the first messages regarding the financial instrument, (b) the second messages to generate respective second sentiment scores reflecting respective sentiments expressed in the second messages regarding the financial instrument, and (c) the third messages to generate respective third sentiment scores reflecting respective sentiments expressed in the third messages regarding the financial instrument;
a model generation engine, which is configured to generate an initial mathematical prediction model for the target variable by analyzing the first sentiment scores and the associated first values of the target variable;
a model refiner, which is configured to generate an incremental mathematical prediction model for the target variable by analyzing the second sentiment scores and the associated second values of the target variable, and to generate a refined mathematical prediction model by combining the initial prediction model with the incremental prediction model;
a market prediction engine, which is configured to predict a future value of the target variable using the refined prediction model with the third sentiment scores as input thereto; and
a report generator, which is configured to generate a report including an indicator of the future value of the target variable in association with an identifier of the financial instrument.

9. The system according to claim 8, wherein the model refiner is configured to generate a plurality of incremental and refined prediction models based on the initial prediction model.

10. The system according to claim 9, wherein the model refiner is configured to generate a new one of the incremental models and a new one of the refined models upon the posting of each of the second messages.

11. The system according to claim 8, wherein the model refiner is configured to combine the initial prediction model with the incremental prediction model by setting the refined prediction model equal to a weighted average of predictions generated by the initial prediction model and predictions generated by the incremental prediction model.

12. The system according to claim 8, further comprising:
a profile database; and
a summary generation module, which is configured to generate and store in the profile database respective structured summaries of the first messages, which summaries comprise the respective first sentiment scores and an identity of the financial instrument, and do not comprise complete textual contents of the respective first messages,
wherein the model generation engine is configured to analyze the first sentiment scores by reading the first sentiment scores from the respective structured summaries stored in the profile database.

13. The system according to claim 8, wherein the financial instrument comprises a financial instrument of a corporation, and wherein the sentiment engine is configured to analyze one of the first messages posted by a first author to generate a respective one of the first sentiment scores reflecting a respective one of the sentiments implicitly but not explicitly expressed by the first author in the first message regarding the financial instrument, by inferring the first author's sentiment regarding the financial instrument responsively to: (a) a first similarity between (i) a first previous sentiment expressed by the first author in a previous message and (ii) one or more second previous sentiments expressed by one or more respective second authors in one or more previous messages, and (b) a second similarity between (i) a first current sentiment expressed by the first author in the first message regarding an aspect of the corporation other than the financial instrument and (ii) one or more second current sentiments expressed by the one or more respective second authors in respective ones of the first messages regarding the aspect of the corporation.

14. The system according to claim 8, further comprising a message clustering engine, which is configured to identify one or more topics discussed in respective first messages, and wherein the model generation engine is configured to generate the initial prediction model by ascertaining respective levels of influence of the topics on the first values of the target variable, and assigning respective weights in the initial prediction model to the respective sentiments expressed in the first messages based in part on the respective levels of influences of the topics discussed in the respective first messages.

15. Apparatus for use with online message servers, the apparatus comprising:
an interface; and
a processor, configured to scan, via the interface, the online message servers to identify a plurality of first messages posted during a first period of time, which first messages contain information regarding a financial instrument; receive, via the interface, first objective quantitative data reflecting respective first values of a target variable associated with the financial instrument, such first values measured after the respective first messages are posted; analyze the first messages to generate respective first sentiment scores reflecting respective sentiments expressed in the first messages regarding the financial instrument; generate an initial mathematical prediction model for the target variable by analyzing the first sentiment scores and the associated first values of the target variable; scan, via the interface, the online message servers to identify one or more second messages posted during a second period of time after the first period of time, which second messages contain information regarding the financial instrument; receive second objective quantitative data reflecting respective second values of the target variable associated with the financial instrument, such second values measured after the second messages are posted; analyze the second messages to generate respective second sentiment scores reflecting respective sentiments expressed in the second messages regarding the financial instrument; generate an incremental mathematical prediction model for the target variable by analyzing the second sentiment scores and the associated second values of the target variable; generate a refined mathematical prediction model by combining the initial prediction model with the incremental prediction model; scan, via the interface, the online message servers to identify a plurality of third messages posted during a third period of time after the second period of time, which third messages contain information regarding the financial instrument; analyze the third messages to generate respective third sentiment scores reflecting respective sentiments expressed in the third messages regarding the financial instrument; predict a future value of the target variable using the refined prediction model with the third sentiment scores as input thereto; and report, to a user via the interface, an indicator of the future value of the target variable in association with an identifier of the financial instrument.

16. A computer software product comprising a tangible computer-readable medium in which program instructions are stored, which instructions, when read by a computer, cause the computer to scan online message servers to identify a plurality of first messages posted during a first period of time, which first messages contain information regarding a financial instrument; receive first objective quantitative data reflecting respective first values of a target variable associated with the financial instrument, such first values measured after the respective first messages are posted; analyze the first messages to generate respective first sentiment scores reflecting respective sentiments expressed in the first messages regarding the financial instrument; generate an initial mathematical prediction model for the target variable by analyzing the first sentiment scores and the associated first values of the target variable; scan the online message servers to identify one or more second messages posted during a second period of time after the first period of time, which second messages contain information regarding the financial instrument; receive second objective quantitative data reflecting respective second values of the target variable associated with the financial instrument, such second values measured after the second messages are posted; analyze the second messages to generate respective second sentiment scores reflecting respective sentiments expressed in the second messages regarding the financial instrument; generate an incremental mathematical prediction model for the target variable by analyzing the second sentiment scores and the associated second values of the target variable; generate a refined mathematical prediction model by combining the initial prediction model with the incremental prediction model; scan the online message servers to identify a plurality of third messages posted during a third period of time after the second period of time, which third messages contain information regarding the financial instrument; analyze the third messages to generate respective third sentiment scores reflecting respective sentiments expressed in the third messages regarding the financial instrument; predict a future value of the target variable using the refined prediction model with the third sentiment scores as input thereto; and report, to a user, an indicator of the future value of the target variable in association with an identifier of the financial instrument.

17. The product according to claim 16, wherein the instructions cause the computer to generate a plurality of incremental and refined prediction models based on the initial prediction model.

18. The product according to claim 16, wherein the instructions cause the computer to combine the initial prediction model with the incremental prediction model by setting the refined prediction model equal to a weighted average of predictions generated by the initial prediction model and predictions generated by the incremental prediction model.

19. The product according to claim 16, further comprising a memory, wherein the instructions cause the computer to:
generate and store in the memory respective structured summaries of the first messages, which summaries comprise the respective first sentiment scores and an identity of the financial instrument, and do not comprise complete textual contents of the respective first messages, and
analyze the first sentiment scores by reading the first sentiment scores from the respective structured summaries stored in the memory.

20. The product according to claim 16, wherein the financial instrument comprises a financial instrument of a corporation, and wherein the instructions cause the computer to analyze one of the first messages posted by a first author to generate a respective one of the first sentiment scores reflecting a respective one of the sentiments implicitly but not explicitly expressed by the first author in the first message regarding the financial instrument, by inferring the first author's sentiment regarding the financial instrument responsively to: (a) a first similarity between (i) a first previous sentiment expressed by the first author in a previous message and (ii) one or more second previous sentiments expressed by one or more respective second authors in one or more previous messages, and (b) a second similarity between (i) a first current sentiment expressed by the first author in the first message regarding an aspect of the corporation other than the financial instrument and (ii) one or more second current sentiments expressed by the one or more respective second authors in respective ones of the first messages regarding the aspect of the corporation.

21. The product according to claim 16, wherein the instructions cause the computer to generate the initial prediction model by identifying one or more topics discussed in respective first messages, ascertaining respective levels of influence of the topics on the first values of the target variable, and assigning respective weights in the initial prediction model to the respective sentiments expressed in the first messages based in part on the respective levels of influences of the topics discussed in the respective first messages.
